(19) United States
(12) Patent Application Publication
(10) Pub. No.: US 2025/0189821 A1
(43) Pub. Date: Jun. 12, 2025

(54) MANUFACTURING METHOD FOR FREE TORIC LENS

(71) Applicants: Jiangsu Kangnaite Optics Co., Ltd, Nantong (CN); Shanghai Konnet Optics Co., Ltd, Shanghai (CN)

(72) Inventors: Chuanbao Wang, Nantong (CN); Hongbin Fan, Nantong (CN)

(21) Appl. No.: 18/963,736

(22) Filed: Nov. 28, 2024

(30) Foreign Application Priority Data
Dec. 7, 2023 (CN) 202311667003.6

(51) Int. Cl. G02C 7/02

(52) U.S. Cl. CPC G02C 7/027

(57) ABSTRACT

Disclosed is a manufacturing method for a free toric lens, which improves the degree of freedom through point-by-point optimization of a plurality of meridians with different angles in an entire plane. The manufacturing method includes the following steps: S1: constructing a simplified lens-eye model; and S2: determining a focal power F₂ and a curvature radius r₂₀ of a vertex. Free toric coefficients of vertical and horizontal meridians are calculated; then due to the rotation symmetry of the lens, it is only considered that in a first quadrant of a curved surface, and the curved surface shape of a free toric surface is determined according to rise data of each point on the taken meridians, so that the manufactured lens is thinner, and clearer in imaging.

### CROSS-REFERENCE TO RELATED APPLICATION

This application claims priority of Chinese Patent Application No. 202311667003.6, filed on Dec. 7, 2023, the entire contents of which are incorporated herein by reference.

### TECHNICAL FIELD

The present disclosure relates to the technical field of lenses, and particularly to a manufacturing method for a free toric lens.

### BACKGROUND

Eyes are important organs for people to acquire information. To acquire external information clearly and accurately, it is necessary to improve the visual system of adolescent myopic patients by correcting ametropia. Usually, there are two methods: one is to wear optical lenses, including frame glasses and contact lenses; and the other one is to change a certain dioptric element of human eyes, such as an excimer laser corrective surgery etc.

Furthermore, with the development of the times, people's requirements for lens design are not only to see things clearly, but also to be more personalized, novel and comfortable. Ordinary inner aspherical lenses and double aspherical lenses are only to optimize two meridians, has low degree of freedom and cannot better control aberration, thereby affecting the visual experience. Furthermore, for people with complex vision correction demands, the conventional lenses cannot provide the best vision correction; and the visual area of the conventional lenses is usually relatively small, which means that the visual field at an edge part may be limited.

### SUMMARY

An objective of the present disclosure is to provide a manufacturing method for a free toric lens to solve the problems set forth in the above background.

To achieve the above-mentioned objective, the present disclosure provides the following technical solution: a manufacturing method for a free toric lens, which improves the degree of freedom through point-by-point optimization of a plurality of meridians with different angles in an entire plane. The manufacturing method includes the following steps:
S1: constructing a simplified lens-eye model;
S2: determining a focal power F₂ and a curvature radius r₂₀ of a vertex;
S3: calculating main aberrations affecting the imaging quality: an oblique axis astigmatism, a field curvature and a distortion;
S4: performing point-by-point optimization using a recursive algorithm: due to the greatest influence of the oblique axis astigmatism on the imaging definition, taking the oblique axis astigmatism as a primary aberration required to be corrected during lens designing, performing oblique axis astigmatism compensation, repeating the above operation for points on two meridians, and performing point-by-point optimization using the recursive algorithm, wherein:

$${P}_{B} = 1 + {( \frac{{r}_{20}}{{y}_{2}} )}^{2} \cdot \{ 1 - {[ \frac{{F}_{2}}{( {F}_{2} - T )} ]}^{\frac{2}{3}} \}$$

$${P}_{C} = 1 + {( \frac{{r}_{20}}{{x}_{2}} )}^{2} \cdot \{ 1 - {[ \frac{{F}_{2}}{( {F}_{2} - T )} ]}^{\frac{2}{3}} \}$$

y₂ and x₂ are heights of intersection points of light and the horizontal and vertical meridians on a surface of the lens, that is, a height from emergent light to an optical axis, and T is a tangential focal power error in directions of the horizontal and vertical meridians;
S5: calculating free toric coefficients: due to the rotation symmetry of the lens, considering that in a first quadrant of the curved surface, dividing the first quadrant into one area every 10°, taking one meridian in each area, with a total of 10 meridians, and calculating the free toric coefficients except the horizontal and vertical meridians by the following formula:

$$P = {P}_{B} - \frac{( {P}_{B} - {P}_{C} ) θ}{90}$$

where θ represents a rotation angle of the taken meridian relative to a horizontal direction; and
S6: correcting the field curvature and the distortion: substituting the obtained toric coefficient of each meridian into a rise formula taking a hyperbolic quadric surface formula as a base and performing correction using a plurality of higher order terms to obtain discrete data points, and finally reconstructing a free toric rear surface by a least square method with the following formula:

$$z = \frac{{c}_{x} {x}^{2} + {c}_{y} {y}^{2}}{1 + \sqrt{1 - {P}_{B} {{c}_{x}}^{2} {x}^{2} - {P}_{C} {c}_{y}^{2} {y}^{2}}} + {Br}^{4} + {Cr}^{6} + {Dr}^{8} + {Er}^{10}$$

wherein cₓ and c_{y} represent curvatures in x and y directions respectively, cₓ=c_{y}=1/r₂₀, r represents the height of incident light on the curved surface, B, C, D and E are higher-order free toric coefficients, and x and y represent the coordinates of a projection of a certain point on the curved surface on an xoy plane along a z-axis direction.

As a further improvement of the present disclosure, the step S1 includes the following steps:
establishing a three-dimensional rectangular coordinate system by taking a vertex of a front surface of the lens as an original point, so that the center of the lens falls on a z axis, the vertical meridian of the lens is parallel to a y axis, and the horizontal meridian of the lens is parallel to an x axis.

As a further improvement of the present disclosure, the step S2 includes the following steps:
setting the front and rear surfaces of the lens as spherical surfaces, and determining a focal power F₂ and a curvature radius r₂₀ of a vertex of the rear surface according to a given base curve F₁, a curvature radius r₁₀, a central thickness d and a refractive index n, wherein the focal powers of the front and rear surfaces in the horizontal and vertical directions are equal since the designed lens does not have astigmatism.

$$As a further improvement of the present disclosure , {r}_{10} = 1000 ( n - 1 ) / {F}_{1}$$

$${r}_{20} = 1000 ( 1 - n ) / {F}_{2}$$

wherein n is a refractive index of a lens medium.

As a further improvement of the present disclosure, PB and Pc in the step S4 are the free toric coefficients of the meridians in the vertical and horizontal directions respectively.

As a further improvement of the present disclosure, in the step S3, the method of calculating the oblique axis astigmatism, the field curvature and the distortion is to reversely trace the vertical and horizontal meridians from an eye rotation center at a 30° field of view, calculate an intersection point y₂ of the light and the vertical meridian of the rear surface and an intersection point x₂ of the light and the horizontal meridian, calculate a tangential oblique vertex spherical focal length f_{T} and a sagittal oblique vertex spherical focal length f_{S} of the lens through forward light tracing so as to calculate a tangential focal power F_{T} and a sagittal focal power F_{S}, and perform subtraction with F₂ to calculate a tangential error T and an arc sagittal error S so as to calculate the main aberrations affecting the imaging quality: the oblique axis astigmatism (OAE), the field curvature (MOE) and the distortion.

As a further improvement of the present disclosure, in the step S4, the operation is repeated to remove points other than the 30° field of view.

As a further improvement of the present disclosure, the B, C, D and E may be solved by using zemax software.

Compared with the prior art, the present disclosure has the following advantageous effects:
according to the present disclosure, a simplified lens-eye model is constructed first; a three-dimensional rectangular coordinate system is established by taking a vertex of a front surface of the lens as an original point; then the two meridians in the horizontal and vertical directions are subjected to point-by-point optimization by using light tracing, free toric coefficients of vertical and horizontal meridians are calculated; then due to the rotation symmetry of the lens, it is only considered that in a first quadrant of a curved surface, the first quadrant is divided into one area every fixed angle; one meridian is taken in each area; the free toric coefficients are calculated using a formula of taking out angles of the meridians except the horizontal and vertical meridians; the calculated free toric coefficients are substituted into a rise formula taking a hyperbolic quadric surface formula as a base and performing correction by using a plurality of higher-order terms; and finally, the curved surface shape of a free toric surface is determined according to rise data of each point on the taken meridians, so that the manufactured lens is thinner, clearer in imaging and more comfortable to wear.

### BRIEF DESCRIPTION OF THE DRAWINGS

FIG. 1 is a schematic diagram of a lens optimization principle A according to the present disclosure;

FIG. 2 is a schematic diagram of a lens optimization principle B according to the present disclosure;

FIG. 3 is a distortion comparison diagram of a free toric lens according to the present disclosure and a spherical lens with the same specification;

FIG. 4 is an OAE comparison diagram of a free toric lens according to the present disclosure and a spherical lens with the same specification; and

FIG. 5 is an MOE comparison diagram of a free toric lens according to the present disclosure and a spherical lens with the same specification.

### DETAILED DESCRIPTION

To make the technical problems to be solved, technical solutions and advantageous effects of the present disclosure clearer, the present disclosure will be described in more detail with reference to the drawings and embodiments. It should be understood that the described specific embodiments are merely used to explain the present disclosure, rather than to limit the present disclosure.

It should be noted that when an element is referred to as being “fixed”, “mounted”, “connected” or “disposed” on another element, the element may be directly or indirectly on another element. It should be understood that orientations or position relationships indicated by terms “upper”, “lower”, “front”, “rear”, “left”, “right”, “vertical”, “horizontal”, “top”, “bottom”, “inner”, “outer” and the like are based on orientations or position relationships shown in the drawings, are merely for facilitating the description of the present disclosure and simplifying the description, but not for indicating or implying that the mentioned device or elements must have a specific orientation and must be constructed and operated in a specific orientation, and thus, cannot be understood as a limitation to the present disclosure.

As a further improvement of the present disclosure, the terms “first”, “second”, “third” and the like are used only for description and should not be interpreted as an indication or implication of relative importance or an implicit indication of the number of technical features. Therefore, features defined by “first” and “second” can explicitly or implicitly include one or more of these features.

### Embodiment 1

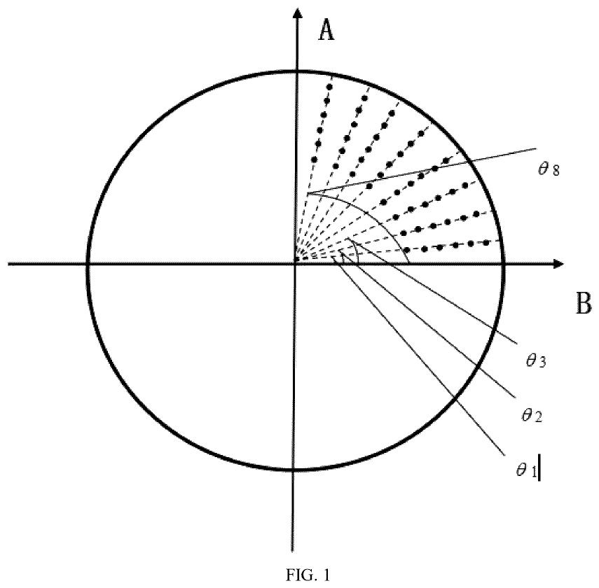

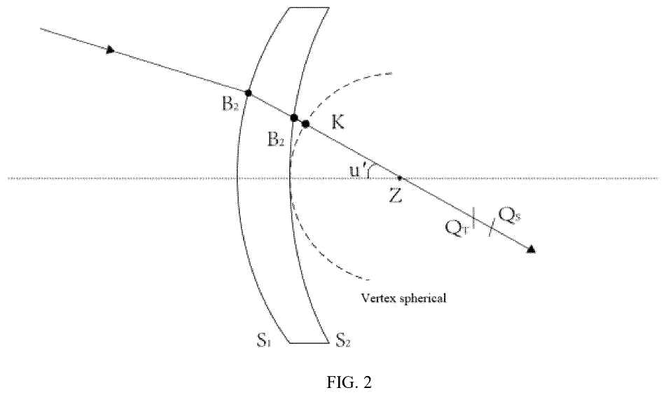

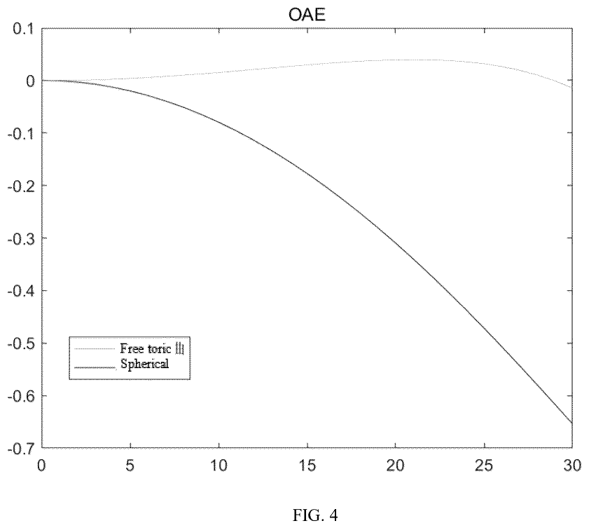

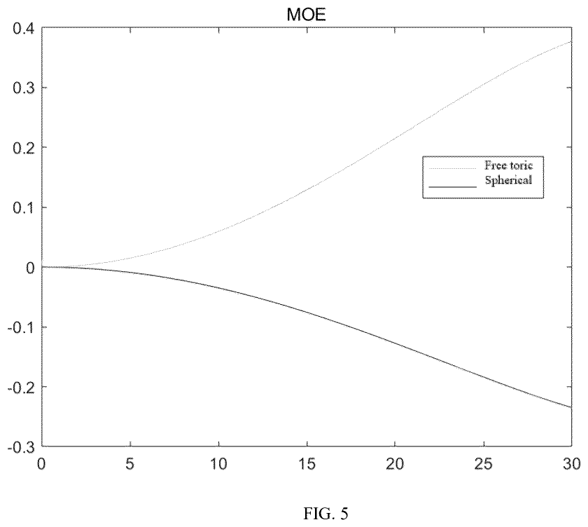

Referring to FIGS. 1-5, the present disclosure provides a technical solution: a manufacturing method for a free toric lens, which improves the degree of freedom through point-by-point optimization of a plurality of meridians with different angles in an entire plane. The manufacturing method includes the following steps:
S1: establishing a three-dimensional rectangular coordinate system by taking a vertex of a front surface of the lens as an original point, so that the center of the lens falls on a z axis, the vertical meridian of the lens is parallel to a y axis, and the horizontal meridian of the lens is parallel to an x axis;
S2: setting the front and rear surfaces of the lens as spherical surfaces, and determining a focal power F₂ and a curvature radius r₂₀ of a vertex of the rear surface according to a given base curve F₁, a curvature radius r₁₀, a central thickness d and a refractive index n, wherein the focal powers of the front and rear surfaces in the horizontal and vertical directions are equal since the designed lens does not have astigmatism;
S3: calculating main aberrations affecting the imaging quality: an oblique axis astigmatism, a field curvature and a distortion. With a geometric light tracing algorithm, as shown in FIG. 2, incident light obliquely enters at u′=30° and passes through a rotation center to intersect with a vertex sphere at K and intersect with inner and outer surfaces of the lens at points B₂ and B₁ respectively, an incident angle i and an emergent angle i′ of the incident light on each surface may be calculated using an optical path calculation standard equation, and the following equations are suitable for both the front and rear surfaces;

$$sin {i}^{′} = \frac{( {l}^{′} - {r}_{0} ) sin {u}^{′}}{r}$$

$$sin i = \frac{{n}^{′}}{n} sin {i}^{′}$$

$$u = {u}^{′} + {i}^{′} - i$$

$$l = {r}_{0} + {r}_{0} \frac{sin i}{sin u}$$

where n and n′ are refractive indexes of incident and emergent media respectively, i and i′ are the incident angle and emergent angle of the light on the surface respectively, u and u′ are included angles between the incident light and emergent light and an optical axis respectively, l and l′ are horizontal distances between the intersection points of the incident light and emergent light and the optical axis and the intersection points of the incident light and emergent light and the surface of the lens respectively, and r0 is a curvature radius of the surface of the lens.

The coordinate position of the intersection point of the light and each surface is obtained through forward light tracing, and the positions of a meridian image and a sagittal image are calculated using a Coddington equation so as to calculate the main aberrations affecting the imaging quality: the oblique axis astigmatism (OAE), the field curvature (MOE) and the distortion;

$$\frac{{n}^{′}}{{s}^{′}} - \frac{n}{s} = \frac{{n}^{′} cos {i}^{′} - n cos i}{{r}_{s}}$$

$$\frac{{n}^{′} {cos}^{2} {i}^{′}}{{t}^{′}} - \frac{n {cos}^{2} i}{t} = \frac{{n}^{′} cos {i}^{′} - n cos i}{{r}_{T}}$$

where s and s′ are an arc sagittal object distance and an arc sagittal image distance respectively, t and t′ are a meridian object distance and a meridian image distance respectively, and r_{S} and r_{T} are curvature radii of arc sagittal and meridian surfaces respectively;
in particular, the tangential error is the difference between the positions and directions of the actual emergent light and the ideal emergent light because the light is incident at different points of an aspherical lens or a curved optical element. For example, in a tangential plane shown in FIG. 2, assuming that the shown lens is +8.00D and the focal power of the front surface of the lens is +3.00D, the vergence is +7.75D when light passes through the lens and arrives at the point K, which means that a tangential focal power error of −0.25D is present. To eliminate the tangential focal power error, the vertical and horizontal meridians are first reversely traced from the eye rotation center at the 30° field of view by the geometric light tracing algorithm, and the height y₁ of an intersection point of the light and the vertical meridian of the rear surface and the height x₁ of an intersection point of the light and the horizontal meridian are calculated. In FIG. 2, the incident light is affected by astigmatism after refraction to form a tangential image at a position Q_{T} and a sagittal image at a position Q_{S}. The distance KQ_{T} is a tangential oblique vertex spherical focal length, recorded as f_{T}. The distance KQ_{T} is a sagittal oblique vertex spherical focal length, recorded as f_{S}. When f_{T} and f_{S} are measured in meters, the tangential focal power is F_{T}=1/f_{T} and the sagittal focal power is F_{S}=1/f_{S}. The tangential focal power F_{T} and the sagittal focal power F_{S} may be calculated through forward light tracing, then the tangential error is T=F_{T}−F₂ and the sagittal error is S=F_{S}−F₂, so that the main aberrations affecting the imaging quality: the oblique axis astigmatism (OAE), the field curvature (MOE) and the distortion may be calculated;
S4: performing point-by-point optimization using a recursive algorithm: due to the greatest influence of the oblique axis astigmatism on the imaging definition, taking the oblique axis astigmatism as a primary aberration required to be corrected during lens designing, performing oblique axis astigmatism compensation, repeating the above operation for points on two meridians (other than the points beyond the 30° field of view), and performing point-by-point optimization using the recursive algorithm, wherein:

$${P}_{B} = 1 + {( \frac{{r}_{20}}{{y}_{2}} )}^{2} \cdot \{ 1 - {[ \frac{{F}_{2}}{( {F}_{2} - T )} ]}^{\frac{2}{3}} \}$$

$${P}_{C} = 1 + {( \frac{{r}_{20}}{{x}_{2}} )}^{2} \cdot \{ 1 - {[ \frac{{F}_{2}}{( {F}_{2} - T )} ]}^{\frac{2}{3}} \}$$

y₂ and x₂ are heights of intersection points of light and the horizontal and vertical meridians on a surface of the lens, that is, a height from emergent light to an optical axis, T is a tangential focal power error in directions of the horizontal and vertical meridians, and P_{B} and P_{C} are the free toric coefficients of the meridians in the vertical and horizontal directions respectively;
S5: calculating free toric coefficients: due to the rotation symmetry of the lens, considering that in a first quadrant of the curved surface, dividing the first quadrant into one area every 10°, as shown in FIG. 1, θ₁, θ₂, θ₃ and so on until θ₈ in the figure, a total of 8 θ angles, taking one meridian in each area, with a total of 10 meridians, and calculating the free toric coefficients except the horizontal and vertical meridians by the following formula:

$$P = {P}_{B} - \frac{( {P}_{B} - {P}_{C} ) θ}{90}$$

where θ represents a rotation angle of the taken meridian relative to a horizontal direction; and
S6: correcting the field curvature and the distortion: substituting the obtained toric coefficient of each meridian into a rise formula taking a hyperbolic quadric surface formula as a base and performing correction using a plurality of higher order terms to obtain discrete data points, and finally reconstructing a free toric rear surface by a least square method with the following formula:

$$z = \frac{{c}_{x} {x}^{2} + {c}_{y} {y}^{2}}{1 + \sqrt{1 - {P}_{B} {{c}_{x}}^{2} {x}^{2} - {P}_{C} {c}_{y}^{2} {y}^{2}}} + {Br}^{4} + {Cr}^{6} + {Dr}^{8} + {Er}^{10}$$

where cₓ and c_{y} represent curvatures in the x and y directions respectively, cₓ=c_{y}=1/r₂₀, r represents the height of the incident light on the curved surface, x and y represent the coordinates of a projection of a certain point on the curved surface on an xoy plane along a z-axis direction, and B, C, D and E are higher-order free toric coefficients (B, C, D and E may be solved by zemax software). First, a hyperboloid quadric surface is created or imported in the zemax, the higher-order coefficient for correction is selected, and the selected higher-order coefficient is used to establish a correction model. The model associates the higher-order coefficient with the shape of the curved surface, an optimization tool is used in the zemax to run correction. In the optimization process, the zemax automatically adjusts the selected high-order coefficient to minimize the OAE, the MOE and the distortion, so that a simulated result is matched with a required optical performance, and a value of the high-order coefficient may be solved, where r represents the height of the incident light on the curved surface, x and y represent the coordinates of a production of a certain point on the xoy plane along the z-axis direction, and z represents the distance between the curved surface and the xoy plane along the z-axis direction, that is, the rise of the curved surface.

$$As a further improvement of the present disclosure , {r}_{10} = 1000 ( n - 1 ) {/}_{F 1}$$

$${r}_{20} = 1000 ( 1 - n ) / {F}_{2}$$

wherein n is a refractive index of a lens medium.

As a further improvement of the present disclosure, in the step S3, the method of calculating the oblique axis astigmatism, the field curvature and the distortion is to reversely trace the vertical and horizontal meridians from an eye rotation center at a 30° field of view, calculate an intersection point y₂ of the light and the vertical meridian of the rear surface and an intersection point x₂ of the light and the horizontal meridian, calculate a tangential oblique vertex spherical focal length f_{T} and a sagittal oblique vertex spherical focal length f_{S} of the lens through forward light tracing so as to calculate a tangential focal power F_{T} and a sagittal focal power F_{S}, and perform subtraction with F₂ to calculate a tangential error T and an arc sagittal error S so as to calculate the main aberrations affecting the imaging quality: the oblique axis astigmatism (OAE), the field curvature (MOE) and the distortion.

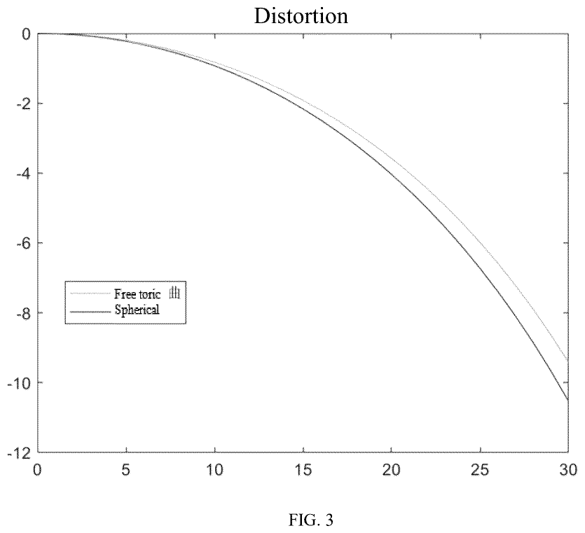

In the present disclosure, the spectacle lens with the lens refractive index of 1.74 and the diopter of −8.00D is optimized through the above implementation, and a comparison result between the spherical mirror with the same specification and the optimized lens is shown in Table 1. For the oblique axis astigmatism, imaging in two directions is not at the same point, which has the greatest influence on the definition of an image, so the present disclosure gives priority to optimize the oblique axis astigmatism to a minimum at the cost of part of the field curvature value, 0.64D is optimized compared with the spherical lens, and excellent definition from the center to the periphery is provided. Although the field curvature value is slightly greater than that of the spherical lens, the field curvature value is also within an acceptable range of glasses. The distortion will not change the definition of the image, but will affect the shape of the image. The distortion of the free toric lens is optimized by 1.1% compared with the spherical lens, so the shape of the image is corrected. The optimization principle is shown in FIG. 2, and the comparison diagrams of the distortion, the OAE and the MOE are shown in FIGS. 3, 4 and 5.

TABLE 1

| | | |
|---|---|---|
| Type | Free toric lens | Spherical lens |

| | | |
|---|---|---|
| Diopter | −8.00D | −8.00D |

| | | | | |
|---|---|---|---|---|
| Diameter of lens | 75 | mm | 75 | mm |
| Curvature radius of front | 370 | mm | 370 | mm |
| surface | | | | |
| Curvature radius of rear | 74 | mm | 74 | mm |
| surface | | | | |

| | | |
|---|---|---|
| Free toric coefficient | P_{B} = −0.19 | P_{B} = 1 |
| | P_{C} = −2.7 | P_{C} = 1 |

| | | | | |
|---|---|---|---|---|
| Central thickness | 1.2 | mm | 1.2 | mm |
| Edge thickness | 5.7 | mm | 6.4 | mm |

| | | |
|---|---|---|
| Refractive index | 1.74 | 1.74 |
| Oblique axis astigmatism | −0.01 | −0.65 |
| Field curvature | 0.37 | −0.24 |
| Distortion | −9.4% | −10.5% |

It is to be noted that relational terms such as first and second are used merely to distinguish one entity or operation from another entity or operation herein, and do not necessarily require or imply the existence of any such actual relationship or order between these entities or operations. Moreover, the terms “include”, “comprise”, or any other variations thereof are intended to cover non-exclusive inclusions, such that a process, method, item, or device that includes a series of elements not only includes these elements, but also includes other elements that are not explicitly listed, or also includes elements inherent in such process, method, item, or device.

Although the embodiments of the present disclosure have been shown and described above, it may be understood by those skilled in the art that various changes, modifications, replacements and variations can be made in these embodiments without departing from the principle and spirit of the present disclosure, and the scope of the present disclosure is defined by the appended claims and equivalents thereof.

1. A manufacturing method for a free toric lens, improving the degree of freedom through point-by-point optimization of a plurality of meridians with different angles in an entire plane, wherein: the manufacturing method comprising the following steps:
S1: constructing a simplified lens-eye model;
S2: determining a focal power F₂ and a curvature radius r₂₀ of a vertex;
S3: calculating main aberrations affecting the imaging quality: an oblique axis astigmatism, a field curvature and a distortion;
S4: performing point-by-point optimization using a recursive algorithm: due to the greatest influence of the oblique axis astigmatism on the imaging definition, taking the oblique axis astigmatism as a primary aberration required to be corrected during lens designing, performing oblique axis astigmatism compensation, repeating the above operation for points on two meridians, and performing point-by-point optimization using the recursive algorithm, wherein:
$${P}_{B} = 1 + {( \frac{{r}_{20}}{{y}_{2}} )}^{2} \cdot \{ 1 - {[ \frac{{F}_{2}}{( {F}_{2} - T )} ]}^{\frac{2}{3}} \}$$
$${P}_{C} = 1 + {( \frac{{r}_{20}}{{x}_{2}} )}^{2} \cdot \{ 1 - {[ \frac{{F}_{2}}{( {F}_{2} - T )} ]}^{\frac{2}{3}} \}$$
y₂ and x₂ are heights of intersection points of light and the horizontal and vertical meridians on a surface of the lens, that is, a height from emergent light to an optical axis, and T is a tangential focal power error in directions of the horizontal and vertical meridians;
S5: calculating free toric coefficients: due to the rotation symmetry of the lens, considering that in a first quadrant of the curved surface, dividing the first quadrant into one area every 10°, taking one meridian in each area, with a total of 10 meridians, and calculating the free toric coefficients except the horizontal and vertical meridians by the following formula:
$$P = {P}_{B} - \frac{( {P}_{B} - {P}_{C} ) θ}{90}$$
wherein θ represents a rotation angle of the taken meridian relative to a horizontal direction; and
S6: correcting the field curvature and the distortion: substituting the obtained toric coefficient of each meridian into a rise formula taking a hyperbolic quadric surface formula as a base and performing correction using a plurality of higher order terms to obtain discrete data points, and finally reconstructing a free toric rear surface by a least square method with the following formula:
$$z = \frac{{c}_{x} {x}^{2} + {c}_{y} {y}^{2}}{1 + \sqrt{1 - {P}_{B} {{c}_{x}}^{2} {x}^{2} - {P}_{C} {c}_{y}^{2} {y}^{2}}} + {Br}^{4} + {Cr}^{6} + {Dr}^{8} + {Er}^{10}$$
wherein cₓ and c_{y} represent curvatures in x and y directions respectively, cₓ=c_{y}=1/r₂₀, r represents the height of incident light on the curved surface, B, C, D and E are higher-order free toric coefficients, and x and y represent the coordinates of a projection of a certain point on the curved surface on an xoy plane along a z-axis direction.

2. The manufacturing method of claim 1, wherein: the step S1 comprises the following steps:
establishing a three-dimensional rectangular coordinate system by taking a vertex of a front surface of the lens as an original point, so that the center of the lens falls on a z axis, the vertical meridian of the lens is parallel to a y axis, and the horizontal meridian of the lens is parallel to an x axis.

3. The manufacturing method of claim 1, wherein: the step S2 comprises the following steps:
setting the front and rear surfaces of the lens as spherical surfaces, and determining a focal power F₂ and a curvature radius r₂₀ of a vertex of the rear surface according to a given base curve F₁, a curvature radius r₁₀, a central thickness d and a refractive index n, wherein the focal powers of the front and rear surfaces in the horizontal and vertical directions are equal since the designed lens does not have astigmatism.

4. The manufacturing method of claim 3, wherein:
$$The manufacturing method of claim 3 , wherein : {r}_{10} = 1000 ( n - 1 ) / {F}_{1}$$
$${r}_{20} = 1000 ( 1 - n ) / {F}_{2}$$
wherein n is a refractive index of a lens medium.

5. The manufacturing method of claim 1, wherein: PB and Pc in the step S4 are the free toric coefficients of the meridians in the vertical and horizontal directions respectively.

6. The manufacturing method of claim 1, wherein: in the step S3, the method of calculating the oblique axis astigmatism, the field curvature and the distortion is to reversely trace the vertical and horizontal meridians from an eye rotation center at a 30° field of view, calculate an intersection point y₂ of the light and the vertical meridian of the rear surface and an intersection point x₂ of the light and the horizontal meridian, calculate a tangential oblique vertex spherical focal length fr and a sagittal oblique vertex spherical focal length f_{S} of the lens through forward light tracing so as to calculate a tangential focal power F_{T} and a sagittal focal power F_{S}, and perform subtraction with F₂ to calculate a tangential error T and an arc sagittal error S so as to calculate the main aberrations affecting the imaging quality: the oblique axis astigmatism (OAE), the field curvature (MOE) and the distortion.

7. The manufacturing method of claim 1, wherein: in the step S4, the operation is repeated to remove points other than the 30° field of view.

8. The manufacturing method of claim 1, wherein: the B, C, D and E are capable of being solved by using zemax software.
